(19) United States
(12) Patent Application Publication
(10) Pub. No.: US 2012/0310667 A1
(43) Pub. Date: Dec. 6, 2012

(54) DYNAMIC CLINICAL PATHWAYS

(76) Inventors: Roy ALTMAN, New City, NY (US); Kenneth ALTMAN, Haworth, NJ (US)

(21) Appl. No.: 13/152,364

(22) Filed: Jun. 3, 2011

(51) Int. Cl. G06Q 50/00; G06Q 10/00

(52) U.S. Cl. 705/3

(57) ABSTRACT

Medical professionals diagnose conditions and prescribe treatments or tests based on a process called a clinical pathway. The criteria within the pathway are largely memory-based. The system here manages the process and allows the physician or other health care professional to focus on decision making and patient care using clinical pathways programmed as spheres in a network connected by business rules.

### FIELD AND BACKGROUND OF THE INVENTION

The present invention relates generally to the field of health care management, and in particular to a new and useful system for helping a health care professional quickly and accurately diagnose an aliment and formulate a treatment.

Co-pending U.S. patent application Ser. No. 12/814,058 for People Relationship Management Software filed on Jun. 11, 2010 by one of the co-inventors of the subject application, discloses a system for an organization having multiple assets each identified by organization meta-data, the system having a management repository for storing connected spheres in a multi-dimensional model. The management repository includes virtual items, business rules and spheres, which are groups of entities, within contexts. The model includes both hierarchical and peer-to-peer connections between the spheres. Each sphere has attributes in the form of sphere data about a selected asset or a group of selected assets, which is leveraged to determine inclusion in the sphere. At least one current asset information repository is connected to the management repository and contains dynamically updated meta-data about the assets, the management repository periodically pulling the updated meta-data from the asset information repository to update and render current the collection of assets that comprise each sphere. Aspects of this system have been augmented and tailored to the field and health care in the present invention.

U.S. patent application Ser. No. 12/814,058 is incorporated herein by reference.

Turning now to the field of health care, containing costs will become a major objective of the medical profession. Patients, however, will continue to demand quality care. The growth of health care costs are rising to an extent that threatens to compromise our economic future and wreck budgets for generations to come, in both the public and private sectors. On Mar. 23, 2010, President Obama signed the Patient Protection and Affordable Care Act, into law. Regardless of the final outcome of this new health care legislation, cost containment will be paramount, along with providing care to more than 40 million additional patients with the current amount of resources and providers. However, people are enjoying the benefits of advances in health care. Life expectancies are increasing. The expectation of quality care will not give way to budgetary concerns. Attempts to rein in costs have focused on limiting the reimbursement for health care professionals. Also, hospitals are stretched in that they provide free care for the uninsured when they show up at emergency rooms. The recent health care legislation attempts to bring most of the uninsured into the health care system, and these people will be demanding care at earlier stages of infirmity, rather than only during an emergency situation. This shifting mission of the healthcare industry is changing traditional relationships, demanding greater value for healthcare dollars spent, and will likely result in a transformation of the healthcare economy. See Bohmer R M, Lee T H, “The shifting mission of healthcare delivery organization,” N Engl J Med, 361: 551-3, 2009 [1] and Porter M E, “A strategy for health care reform—toward a value-based system,” N Engl J Med, 361: 109-112, 2009 [2].

Many in the health care profession agree that as a result of these stressors there will be a shortfall in needed physicians and other professionals to deliver this medical care. Among these reasons are:

1. Lower physician reimbursement and increased malpractice risks resulting in early retirement of existing physicians.

2. Newer emphasis on work-life balance and reduced work-hour habits among younger physicians.

3. Not enough physicians and allied health professionals in the training pipeline to meet the expected needs.

4. An aging population with increased healthcare needs.

5. More than 40 million additional patients to the roles of the insured.

6. Likely increased demand per patient with an increasingly healthcare-savvy population seeking multiple opinions for their care.

Although medical school enrollment is up, there is the risk that talent will be drawn to other fields as the economic realities become apparent.

Therein lays the dilemma of the future of health care: how to continue to provide quality care at lower cost in an environment of scarcer health care resources.

Health care professionals are human, and humans make omissions and mistakes. However, unlike many other professions, the consequences of those mistakes can literally be “life and death.” Therefore, quality control of decisions is paramount. Yet to this day, many processes in health care have not been formalized through the use of protocols. Limited access to information, limited time and the hugely increasing body of medical knowledge, ultimately decreases the chance of favorable heath care outcomes. There is much room in the medical diagnosis and care processes for enhanced efficiencies and oversight. The present invention seeks to addresses those imperatives.

Medical professionals, particularly physicians, spend a long time in school honing their skills. A diagnosis and treatment plan requires knowledge, experience and intuition, while rigorously bound to the scientific method. Yet medical diagnosis is still very memory bound. A physician must keep myriad symptoms and causes in their heads to find the right solution. He or she also relies heavily on experience, yet the experience of a single doctor cannot compare with the collective knowledge of the profession. Contrary to depictions in popular TV doctor shows where the hero-doctor recognizes a highly unusual ailment that was missed by everyone else, in reality this is a rarity. Sometimes the unusual pathway is missed because of the limited experience of the doctor. The other part of being an effective physician is being able to interpret information and make judgments about ordering tests, diagnosing the ailment and proposing treatment. Each case has its own unique aspects. Thus the medical worker is the ultimate knowledge worker, in that he must react to his/her environment and make quick decisions with important consequences.

The medical industry is undergoing dramatic changes. As noted above, there is a need to provide quality services while limiting costs, with necessary oversight.

Health care workers, ranging from physicians, nurses, therapists and first responders, need to make critical decisions based on rapidly changing information (such as evidence-based consensus reports called “clinical practice guidelines” for specific situations). The emerging practice of Adaptive Case Management (ACM) is well equipped to handle this application, in that it assists knowledge workers by providing timely information to make informed decisions in dynamically changing environments.

Medical workers need to keep a myriad of information about symptoms and possible causes in their heads, and winnow down the possibilities until finally arriving at a diagnosis and treatment plan. Along the way, tests are conducted to validate or invalidate hypotheses. When formalized for a specific symptom or disease, this process is called a clinical protocol. A medical professional can either quickly move to a diagnosis based on an expensive test, or first try a medicinal therapy. The choice depends on the doctor's judgment and experience. This “experience” aspect is enhanced by accessing large pools of data which are increasingly changing and growing, adding to the body of knowledge on the subject. It is therefore important to employ a system that provides information about different ailments and guides a medical worker down an accepted pathway toward treatment. This should interact with centralized electronic medical records, contributing towards a more efficient pathway.

A complete audit trail of all decisions would satisfy regulatory requirements. Ultimately, social Business Process Management (BPM) interactions among the users will enhance the process by allowing care to be provided by experts who are not physically present.

Existing Order Entry software is known and does some rudimentary checks, such as reminding medical professionals about harmful drug interactions. This is a reactive rather than a proactive approach and does not guide the medical professionals through a decision pathway.

Electronic Medical Records (EMR) systems are also known that allow remote access to a patient's records and are supplied in a standardized format for quick access and understanding by a medical professional.

Other existing medicine related software products, such as Zynx, attempt to automate clinical pathways. However they are limited in the following ways:

They are based on rigid clinical practice guidelines, and therefore do not have the ability to automatically self-modify based on observed outcomes;

They do not have the ability to represent pathways as flexibly as People Relationship Management software provides (no other software provides the ability to represent relationships as flexibly); and

They cannot link pathways, or spawn a new pathway within a node of an existing pathway, or manage the complexity of parallel pathways.

### SUMMARY OF THE INVENTION

It is an object of the present invention to provide, in the health care field, the ability to support a micro-macro view of relationships by enabling a sphere to contain relationships. Another object is to apply weightings to business rules for sphere inclusion, which enables “fuzzy” logic, that is logic where the result is a probability not a certainty. The system of the invention is front-end to an order entry system (single interface) and retains an audit trail of all decisions in the clinical pathway. The system acts as a decision maker or augmenter and allows a multi-dimensional view of the clinical pathway (linked pathways). The system of the invention uses outcomes to strengthen and weaken pathways that were successful or unsuccessful, respectively. Thus it can “learn” from actual experience and modify accepted protocols.

Another object of the invention is to provide a system that automates the decision process, while providing access to information stores so that the medical or health care professional can make informed decisions. In essence, the present invention takes over the memory intensive aspects which computers do well and humans do not, and administrative tasks in making diagnoses and prescribing treatments. This allows the medical worker to do what humans do best—using their intuition and skill to make decisions that result in positive outcomes for the patient.

A still further object of the invention is to provide a dynamic clinical pathway system for helping medical professionals make informed decisions on courses of treatment for a subject after observing one or more symptom exhibited by the subject, comprising: a computer arrangement containing at least one computer connected to an Electronic Medical Records system and an Order Entry system for allowing real-time access and updates; a dynamic clinical pathway program programmed into the computer arrangement for storing a plurality of connected spheres in a multi-dimensional model, at least some of the spheres being seeded with clinical practice guidelines provided by medical experts and containing documented evidence for clinical pathways based on or extrapolated from symptoms, the seeded spheres being configured with business rules for inclusion according to clinical protocols, and being linked in relationships that define context spheres of clinical pathways based on the documented evidence, the rules being based on indicative information about at least one of: the clinical practice guidelines; the symptoms; and test results that indicate inclusion in a diagnosis; the computer arrangement including an interface for a medical professional to access the dynamic clinical pathway program at an entry sphere and to receive suggestions for clinical pathways to take based on at least one symptom of the subject, the interface providing the medical professional with an Electronic Medical Record of the subject and the allowing access for the medical professional to make decisions to order treatments or tests via the Order Entry system; the dynamic clinical pathway program recording an audit trail of all decisions made by the medical professional in the clinical pathway and for cataloging each audit trail as being a strong pathway or a weak pathway in the recording; and the dynamic clinical pathway program adjusting the business rules for preferentially suggesting the strong pathways over the weak pathways in subsequent use of the Dynamic Clinical Pathway system.

The computer arrangement may comprise a hand-held computing device like a tablet for providing the interface for the medical professional, and an application server computer connected to the hand-held computing device, e.g. wirelessly, the application server computer being connected to the Electronic Medical Records system and to the Order Entry system through a web service.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a flowchart of the genesis of a critical clinical pathway according to the present invention;

FIG. 2 is a flowchart illustrating a clinical pathway for evaluation and management of gastroesophageal reflux (GERD), reprinted with permission from Altman K W, Prufer N, Vaezi M F, “The challenge of protocols for reflux disease—A review and development of a critical pathway,” Otolaryngology Head Neck Surgery (in press);

FIG. 3 is a flowchart that illustrates how a complex disease such as a chronic cough may have many physiologic causes and inter-relationships, as well as overlapping contributions from different diseases;

FIG. 4 is a schematic nodal diagram of the pathway shown in FIG. 2 at the top, and two additional pathways for other diseases at the middle and bottom of the figure, the dashed lines indicating schematic relationships between different pathways;

FIG. 5 is a depiction illustrating that as one traverses relationships within a context, one could arrive at a sphere which explodes into a different context and continues traversing the pathway in the other context;

FIG. 6 shows that the successful path through the pathway (depicted in double line arrows) will have the weightings of all relevant business rules along that path strengthened, the unsuccessful pathways being depicted in single line arrows (business rules along that path will be weakened) and the triple line arrows being relationships that were not traversed in this pathway;

FIG. 7A is a flowchart showing the operation of a first part of a computer program for practicing the system of the present invention; and

FIG. 7B is a flowchart showing to second part of the computer program for practicing the system of the present invention.

### DESCRIPTION OF THE PREFERRED EMBODIMENT

The present invention is a multi-tiered system that uses ACM (Adaptive Case Management) and social BPM (Business Process Management) enhancements in medical clinical pathways and is therefore called Dynamic Clinical Pathways. The invention states the need, anticipates the benefits, and delineates the requirements to solve the problem. The invention is referred to as a system in the strict sense that it is a set of interacting activities and associated hardware and software to solve a particular problem. The inventors have found that a systemic approach is needed.

The system allows medical professionals to focus on using their experience and intuition to make nuanced diagnoses, while letting the system provide the extensive memory needed and structure the process. Severity of the ailment can be aligned with the skill-level of the professional, leaving more complicated cases to scarcer expert physicians. More widely-available and accurate medical treatment at lower costs may result, while also ensuring oversight and transparency.

The Role of Adaptive Case Management:

Adaptive Case Management (ACM) is a practice that strives to provide decision support for the knowledge worker. A knowledge worker is one who does not do repeatable tasks, but who reacts to constantly changing and complex information to use his or her knowledge and judgment to make decisions. Knowledge workers tend to work on high value activities. The diagnosis and care of a patient is just such a high value activity and a medical worker definitely qualifies as a knowledge worker. As explained more fully later in this disclosure, the knowledge worker for the purpose of the present invention, will be referred to as a medical professional (MP).

What the System of the Invention is:

The problem that this invention addresses is not the making of diagnoses but rather it specifically addresses the pain point that medical professionals feel when doing their jobs not having access to the information they need exactly when it is required. In this sense, it is similar to that of any fast paced job requiring a broad knowledge on one or more subjects.

The system of the invention provides the medical professional with information supporting the next decision that he or she has to make, and records that decision. The system maintains an audit trail of decisions to improve its support offering capabilities. Currently, medical records only record illnesses and treatments, but not symptoms and factors applied to the decision making of the diagnosis process. By recording the decisions and ultimate results, the system can offer the professional timely and relevant information. The system does not make any medical decisions but provides the medical professional with the information he/she needs to make the decision, and then records that decision and the outcome to continuously improve its information providing capabilities. The system of the invention is embodied as software running on a mobile device connected to a server housing a vast information repository and also connected to other system (such as electronic medical records and order entry) using a standard protocol for interfacing such as web services.

Unlike classical decision support modules for electronic health records software currently in use, the system here facilitates a clinical pathway from a process standpoint. It also presents an approach at inter relating many decision points in overlapping clinical care processes.

What the System of the Invention is not:

The system disclosed here is not a diagnosis system. There are four important reasons for this:

1. Physician autonomy—and professional autonomy from a system that imposes the diagnosis based on the input information. The system assists the medical professional by providing information, administrative support, and structure to the process, but it is the medical professional who makes the decisions and assumes the ramifications of those decisions.

2. Liability—the liability of an incorrect diagnosis does not fall on the system, or the contributors of content to the system. The diagnosis is made by the medical professional.

3. Adoption—any system is only worthwhile if it is used. There have been attempts at artificial-intelligence driven systems in the past, meant to make diagnoses. These have not been widely adopted. The reason is two-fold: they are not always accurate, and medical professionals may feel threatened by them. It is important that medical professionals view this type of system as helpful and not threatening or cumbersome to use.

4. Not artificial intelligence—this system uses conventional” technology. It is meant to run on a typical Von Neumann architecture machine, without exceptional powerful computing. By contrast, IBM's Watson computer, which recently inked a deal to produce a physician's assistant version of the system, is a massively parallel architecture with 28,000 processors. The present invention uses conventional technology and this has a huge beneficial impact on cost. The only aspect of the invention that might be considered artificial-intelligence is that the system “learns” from experience, but not in the way that massively parallel architected systems do.

Why Social Business Process Management:

Social Business Process Management (BPM) recognizes the need for people to collaborate and interact to achieve a goal, enabled by software and that accommodates this need. The Dynamic Clinical Pathways of this invention qualifies as social BPM for the following reasons:

1. Multiple people in charge of care—patients are treated by multiple physicians and support staff with overlapping roles.

2. Integrated practice unit—the ideal care is provided through an integrated practice unit where all specialists have input to the decision process, yet it's impractical to get all specialists in the same room at the same time for most patient encounters, standardize decision processes for basic care—clinical pathways attempt to standardize decision processes for basic care that were otherwise sporadic and anecdotal.

3. Standardize decision processes for basic care clinical pathways attempt to standardize decision processes for basic care that were otherwise sporadic and anecdotal.

4. All cases contribute to the body of knowledge the recording of data at each step of the process bringing patients to the next step in the pathway results in tacit communication between these specialists.

5. The process of research, to clinical practice guidelines, to protocolization, to dynamic assessment (clinical pathways) involves consensus. The collaboration and debate of current standard of care amongst users of such a system makes its decision processes dynamic.

What is a Clinical Pathway:

Medical professionals diagnose conditions and prescribe treatments based on a process called a clinical pathway. Yet the criteria within the pathway are largely memory-based. There is a need for a system that manages the process and allows the physician to focus on decision making and patient care. This patent application discloses such a system.

As discussed in the background section of this disclosure, medical workers need to keep a myriad of information about symptoms and possible causes in their heads, and winnow down the possibilities until finally arriving at a diagnosis and treatment plan. Along the way, tests are conducted to validate or invalidate hypotheses. When formalized for a specific symptom or disease, this process is called a clinical protocol. Health care workers and health care providers, ranging from physicians, nurses, therapists and first responders, need to make critical decisions based on such as evidence-based consensus reports called clinical practice guidelines. Each of these health care workers and health care providers are referred to as a medical professional for the purpose of this disclosure.

The pathway that can result can be quite complex. A patient may have multiple ailments which either interact or are mutually exclusive. A specific pathway can take a different turn or spawn a whole new pathway. Simple decision tree software will not suffice in creating a robust enough solution for this challenge. The Dynamic Clinical Pathways of the present invention effectively models the decision making processes that physicians or other medical professionals undergo in making diagnoses and prescribing treatments.

Protocols, Pathways, and Complex Disease

How ACM and Social BPM is used for Dynamic Clinical Pathways:

The concept of automating clinical care is fundamentally challenging, sharing the stark contrast between antiseptic business process models, and humanity in the care of patients. While a decision support structure aides clinical decisions, a proper system actually allows the physician and health care provider to maintain a greater amount of patient interaction. The system of the invention reinforces the provider's fund of knowledge, experience, and ability to keep up-to-date with the latest standards of care. This enables them to perform more valuable service, such as adding their clinical intuition to the care regimen, getting to know their patients better, and communicating compassion.

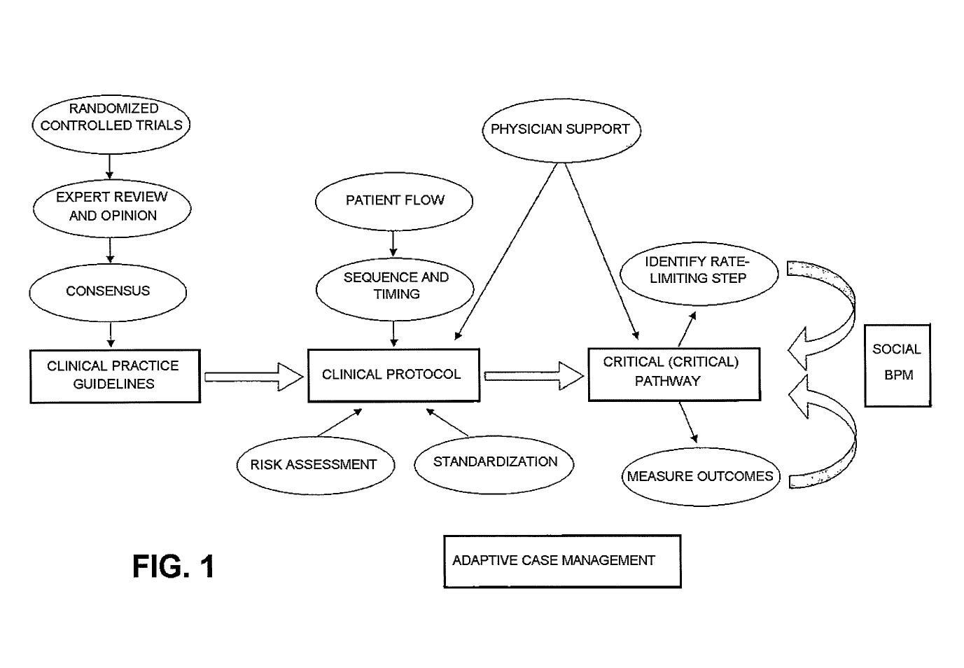

It is necessary to take a standardized approach to the development of a decision support structure to be able to construct such decision trees systematically for many different diseases. This process is shown in FIG. 1 which is a flowchart of the genesis of a critical clinical pathway according to the present invention.

In FIG. 1, Clinical Practice Guidelines (CPG) are expert consensus statements derived from the highest levels of scientific research for a specific disease. Assembling these recommendations in a group that reflects “Sequence and Timing” and decision processes is called a Clinical Protocol in FIG. 1. Although some clinical protocols are constructed from a single investigator's anecdotal experience (i.e. low level of scientific evidence), the ideal protocol is based on the latest CPGs, which should be derived from the highest level of scientific evidence (randomized controlled trials and translational science like expert review and opinion and consensus). The construction of the Clinical Protocol may also include factors such as patient Flow and risk assessment, and reflects an attempt at standardization of care across different providers.

A Critical (Critical) Pathway in FIG. 1, is an industrial process that seeks to maximize efficiency through identifying and improving upon the rate limiting step. A rate limiting step is anything that results in limiting the cost or time of treatment. See Every N R, Hochman J, Becker R, Kopecky S, Cannon C P, “Critical Pathways. A review,” Circulation, 101:461 465, 2000. [3]. The Clinical Protocol used by the present invention effectively becomes a critical pathway when factors such as optimal timing for ordering tests, successful medical outcomes, costs, or validity of a medical risk assessment, are measured at Measure Outcomes in FIG. 1.

To emphasize that the critical pathway is for clinical purposes, this disclosure will henceforth refer to it as a clinical pathway. This clinical pathway is therefore considered an example of Adaptive Case Management by automating processes to improve the effectiveness of knowledge workers (i.e. the medical professionals). Social BPM comes into play when physicians and others need to collaborate to monitor the outcomes, update the CPG recommendations, and seek to improve upon the clinical pathways.

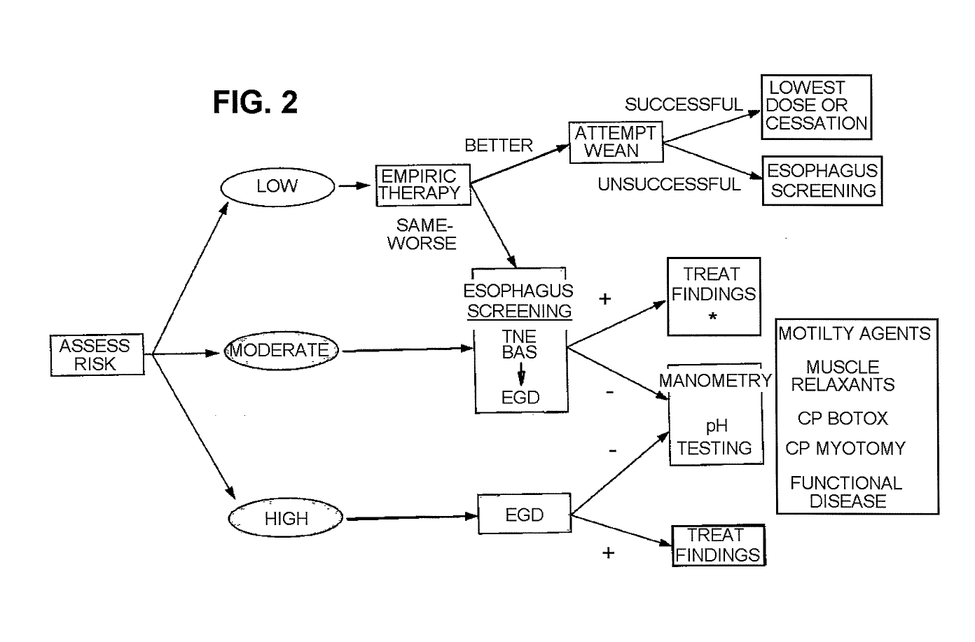

The sequence of developing a clinical pathway is effectively demonstrated in two recent papers. For the example of gastroesophageal reflux disease (GERD), the inventors performed a systematic review of the literature that critically analyzed CPGs and their recommendations. See Altman K W, Prufer N, Vaezi M F, “A review of Clinical Practice Guidelines for reflux disease: toward creating a clinical protocol for the otolaryngologist,” Laryngoscope, in press [4]. Principles of constructing a clinical protocol were then summarized. These principles were used to guide a comparison of existing protocols, and a new protocol was constructed as a synthesis of those reviewed. See Altman K W, Prufer N, Vaezi M F, “The challenge of protocols for reflux disease—A review and development of a critical pathway,” Otolaryngology Head Neck Surgery, 2011 April; 121(4):717-23[5]. Since measuring outcomes of various metrics was built into the design, this is presented as a clinical pathway for reflux disease as shown in FIG. 2.

In FIG. 2, the description of the medical decision-making and explanations of technical terms is beyond the scope of this application, however, FIG. 2 illustrates the clinical pathway because the decision points and lines connecting them are all measureable (TNE—transnasal esophagoscopy, BAS—Barium esophagohram, EGD—esophagogastroduodenoscopy, CP—cricopharyngeus).

This particular pathway introduces medical risk assessment at Assess Risk, as an initial step, and shows decision branching points at being Low, Moderate and High, based on response to empiric medication, Empiric Therapy, and on results from screening tests, Esophagus Screening THE BAS->EGD, or just EGD. The pathway for GERD was chosen for development as it is a fairly linear decision process.

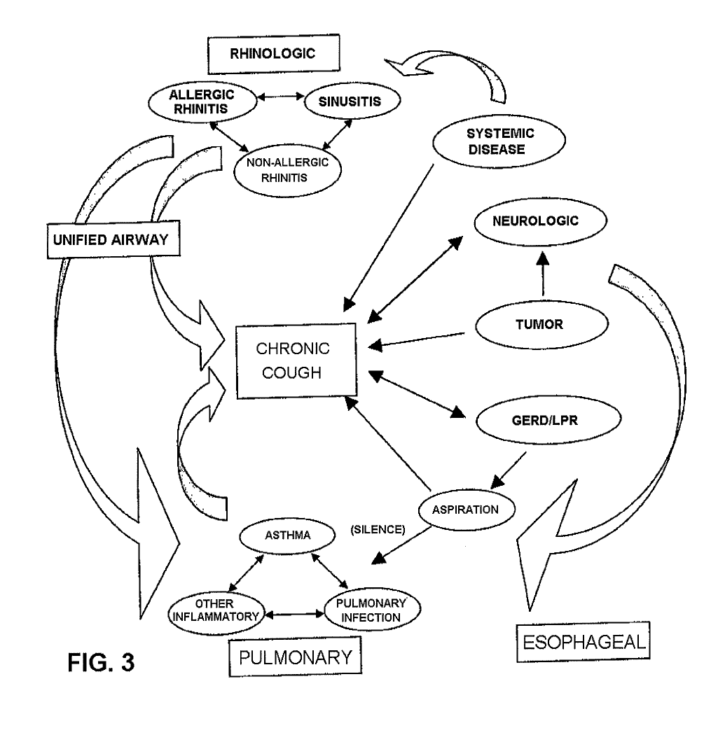

Chronic Cough is a far more complex example, based on the many contributing factors that can cause cough with overlapping physiologic processes that form synergistic effects and is illustrated by FIG. 3. FIG. 3 is a flowchart that illustrates how such a complex disease like a chronic cough may have many physiologic causes and inter-relationships, as well as overlapping contributions from different diseases. See Altman K W, Irwin R S, “Cough: A new frontier in otolaryngology,” Otolaryngology Head Neck Surgery, 2011 March; 144(3):348-52[6].

In this example, Rhinologic diseases are a common cause (such as post nasal drip from allergy or sinusitis). These diseases can cause a cough directly by irritating the vocal folds, or indirectly by aggravating lung disease (such as bronchitis or asthma). Lung disease can also directly cause a cough. GERD is another common cause of cough, and can cause it by directly stimulating nerve endings in the esophagus or larynx, can cause aspiration to the lung which results in a cough, and can itself be caused by the act of coughing, illustrated by the double arrow between Chronic Cough and GERD/LPR. Since there are many overlapping and complicating factors here, the clinical work-up may be inconsistent. One major difference in the approach to a clinical work-up is between serial evaluation and treatment (one trial or test at a time), and parallel evaluation and treatment (where more than one contributing disease may be addressed at the same time). While the computational demands for guiding the linear GERD pathway of FIG. 2 may be straightforward, the ability to construct a computational model for the care pathways needed for cough seen in FIG. 3, is more difficult.

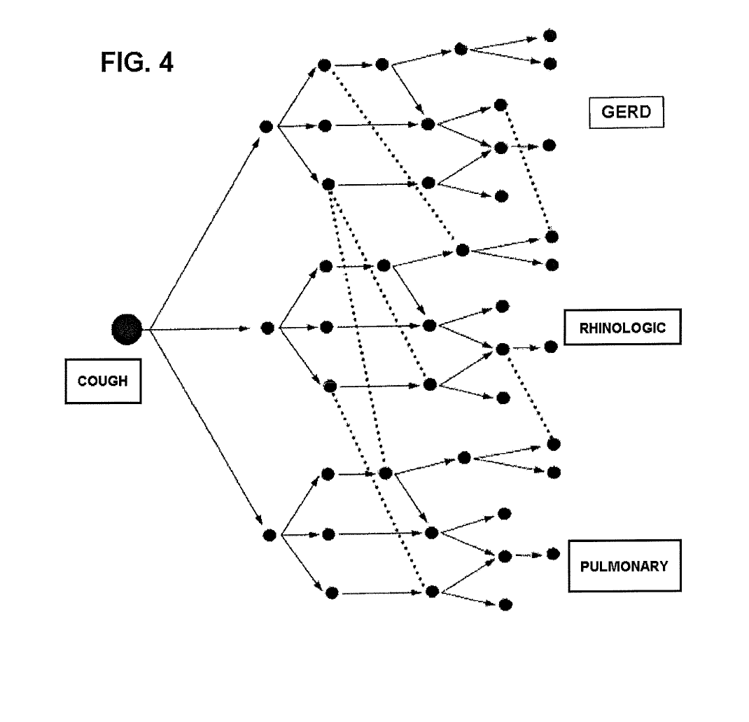

To demonstrate the approach of the invention to computational structure, FIG. 4 is a schematic representation of the linear GERD pathway from FIG. 2, plus two other and more complex pathways of the invention. The diagram for GERD seen at the top of FIG. 4, is displayed using nodes (black circles) to represent points in time during the patient observation and medical decision making process (illustrated by solid lines between the nodes). Two additional pathways are also shown in the schematics in FIG. 4. In the case of an observed Cough (starting point at the left), these three pathways may represent Rhinologic disease at the middle (such as post nasal drip), and Pulmonary disease at the bottom (such as asthma or bronchitis). Since these three disease processes may exacerbate each other for many reasons, they become inter related at different nodes. Relationships between these nodes may be based on timing, common physiology, synergistic effects, and prioritizing testing between two competing diseases diagnoses shown by dotted lines connecting the three pathways. A mathematical representation of these relationships connecting the pathways in a computational model facilitates the parallel work up and treatment of a complex disease.

The relationship between this computer based clinical pathway and the electronic medical record (or EHR) is beyond the scope of this disclosure. There are essentially three possible scenarios that can be considered:

1. The clinical pathway is completely independent of the EHR and only guides the clinician on the next step which they document independently; or

2. The clinical pathway is called-up by the EHR during the course of documentation via keywords, tabs or smart-text currently in use today by some EHR systems; or

3. The clinical pathway itself is used to generate an EHR document.

Nevertheless, documentation of the decision process, test results and patient outcome are vital to successful patient care and communication among physicians and other healthcare providers.

Technical Solution for Dynamic Clinical Pathways:

To automate Clinical Pathways, the solution provided by the present invention has the following characteristics:
Ability to group entities in sets based on common characteristics;
Ability to flexibly define and encode the criteria for set inclusion;
Ability to explode to sub structures and implode to super structures, with no limit on depth of nesting of structures;
Ability to traverse multi dimensional networks and manage the complexities of that navigation; and
Ability to self modify based on feedback mechanisms.

FIGS. 1 to 4 illustrate the pathways that diagnosis and treatment can take. There are many interacting variables. This application defies traditional BPM, which is only able to represent fairly rigid logic paths. Set theory applies because it manages the interactions of variables that constitute inclusion in the set to determine the next step in the process. This can be thought of as a traversal of a complex network. However the connections are determined by stochastic criteria. Thus medical professionals must use their judgment in determining the next step. Previous rule based artificial intelligence (AI) attempts at medical diagnosis used weightings to determine the probability of an outcome. According to the present invention, however, the weighting based probability determines the order that the system would serve up the information to the user. The weightings are the result of observation recorded in the system, so the outcomes influence the system behavior the next instance given the same conditions. The content for the clinical pathways are initially seeded by expert specialists, but evolve and morph over time into more refined criteria.

A set theory/structure nesting/network traversal based processing system was first proposed in a paper by one of the present co-inventors on People Relationship Management published in the 2009 BPM Workflow Handbook and in the incorporated by reference, U.S. patent application Ser. No. 12/814,058. See Altman R, “People Relationship Management—Completing the BPM Value Proposition,” 2009 BPM Workflow Handbook [7].

The original premise of the article and the incorporated patent application was to map the relationships between people in an organization so a workflow system would know the right person to route a transaction to. This was initially geared toward transaction based processes which are the traditional premise of BPM systems. Examples would be Human Resource Management transactions such as processing promotions, benefits changes, and time-tracking, among others. However, it was stated that the underlying technology was capable of tracking relationships between any type of entity. In addition, it has a very rich rule-based engine for inclusion in sets (spheres) based on the relevant meta-data. The discipline of tracking relationships between any type of entity is called Extended Relationship Management, or XRM. The term Extended Relationship Management grew out of Customer Relationship Management (CRM) by extending the capabilities to include relationships between people other than customers. Although the proposed system discussed in this application is not similar to CRM, the acronym fits.

As initially discussed in the Workflow Handbook paper [7] and the incorporated patent application on People Relationship Management, a Sphere was a collection of entities (initially people). Inclusion in a sphere was defined by business rules. Every entity was considered a sphere, whether it was a collection of entities (it can be a collection of different type entities) or a single one. A sphere which cannot be subdivided further was called an elemental sphere. Spheres can be nested any number of times. Spheres can have attributes assigned to them. A business rule can test an elemental sphere's attributes to determine inclusion in a larger sphere. Spheres are connected together in a type of sphere called a Context Sphere, meaning they are related to each other in some way. Putting it all together it is called a relationship: a group of spheres, defined by business rules, related in a context sphere.

Since spheres can represent anything, a sphere can be defined to represent a full pathway, and nested in another sphere. In that way the system can represent explosion to another pathway at a node. Essentially the system allows dynamic criteria for set inclusion, and the ability to manage and navigate very complex network structures with no limitations. In the realm of a transactional BPM system, People Relationship Management can be used to define the relationships between people in an organization in very complex ways that accurately represent the relationships.

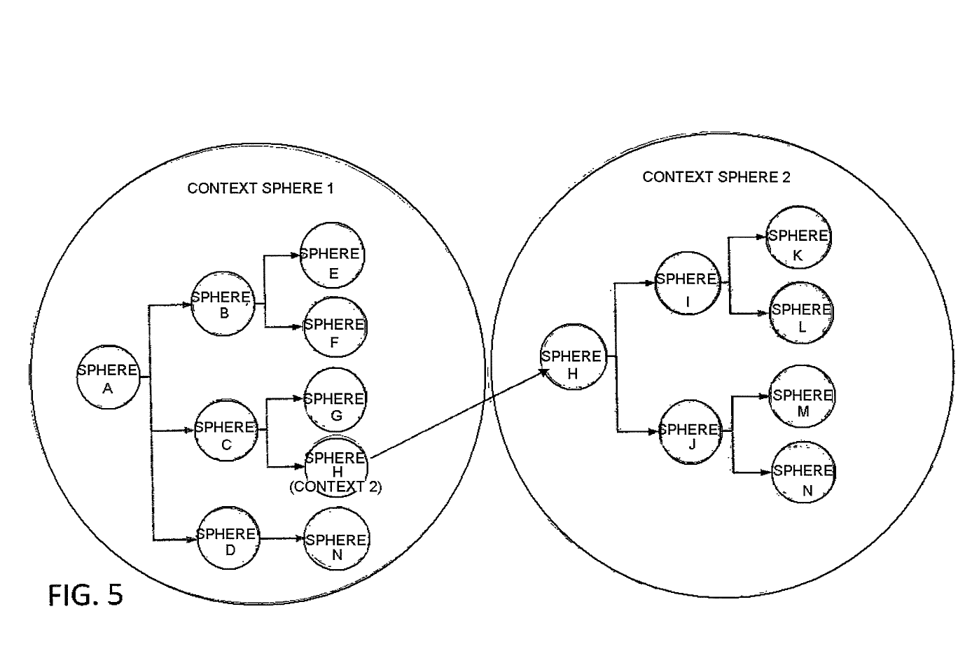

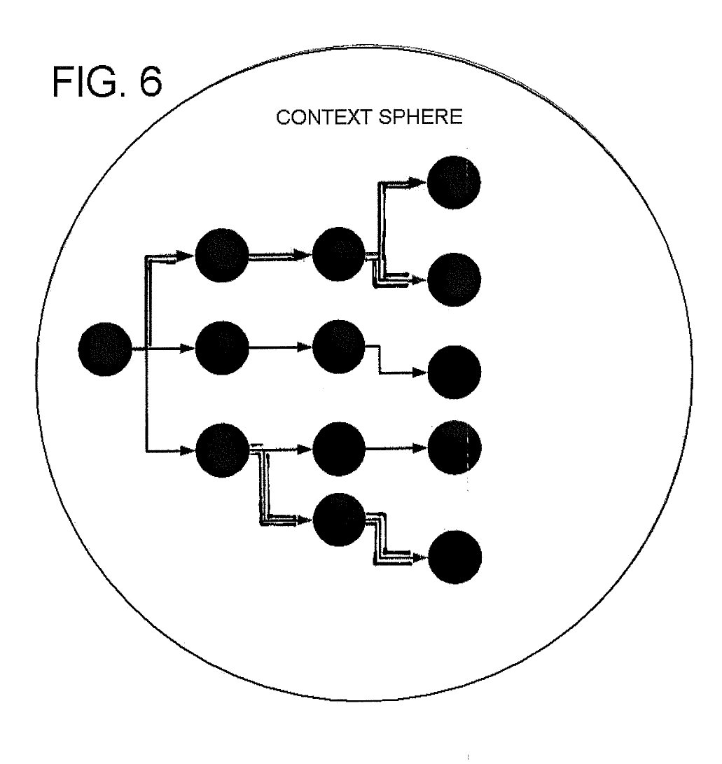

The present invention, as illustrated in FIGS. 5 and 6, expands on this technology to be useful in the field of Dynamic Clinical Pathways (DCP). The model is extended to weight the set inclusion criteria based on feedback loops. Also, unlike a workflow system, where traversal to the next node is sent automatically based on business rules, in DCP the worker, i.e. the medical professional, explicitly chooses which node to move to next. The system makes suggestions based on the rules (initially seeded as clinical practice guidelines) and modified by the experience of the system. Using XRM for DCP, the context would be analogous to the pathway, for instance: diagnosing a cough, or diagnosing chest pain. Each sphere represents a potential diagnosis, or more refined categorization of the condition. The business rules associated with the sphere are the symptoms or test results that indicate inclusion in that diagnosis.

FIG. 5 is a depiction that as one traverses relationships within a context, one could arrive at a sphere which explodes into a different context and continues traversing the pathway in the other context. This is enabled by the XRM improvements over PRM. FIG. 6 shows that the successful path through the pathway (depicted in double line arrows connecting the black circles that represent Spheres, or Context Spheres or nodes) will have the weightings of all relevant business rules along that path strengthened. The unsuccessful pathways are depicted in single line arrows. Business rules along that path will be weakened. The triple line arrows show relationships that were not traversed in this pathway.

How does DCP Work:

Medical experts, who may also be one or more of the medical professionals who will use the invention or who are others with expertise in one or more field of medicine or hearth care, will “seed” the system with clinical practice guidelines. They will configure spheres with business rules for inclusion, and link them in relationships that define the clinical pathway, based on the documented evidence to that point.

The medical professional (hereafter called an MP) will have a hand-held device, such as a tablet computer, which is attached to an application server where a computer program based on the present invention is executing. The application server is connected to an Electronic Medical Records (EMR) system and an Order Entry system through web-services, allowing real-time access and updates. When a session begins the system will read the sphere at the root node of the pathway and then read all next level connected nodes. The system will display the business rules for all of the spheres at that level and attempt to discover the information to resolve the business rules. To get this, it will access medical records through web-services to find the information it needs. The computer arrangement can thus comprise a hand-held computing device for providing the interface for the medical professional, and the application server computer connected by an, e.g. wireless connection like WiFi to the hand-held computing device, the application server computer being connected to the Electronic Medical Records system and to the Order Entry system through a web service, such as to the World Wide Web or other global computer network.

For any information that is unavailable, the system will prompt the MP to query the user to obtain that information. For example, the MP will ask the subject (e.g. the patient) about his or her symptoms or observe the symptoms if they are apparent or is the subject cannot answer. The response or observation will be noted in the system by a few touches on the tablet, and will be immediately transferred to the patient's medical record or EMR. The business rules will fire and list spheres most probable in order of the calculated probability. The system will prompt for tests that would more definitively confirm or reject inclusion in the sphere.

The MP will order tests based on his medical judgment, either accepting or rejecting the probabilities that the system understands at this point. Selecting a test will invoke an Order Entry application, feeding it as much relevant information as is known to this point to avoid duplicate entry. The results of the test are noted in the system. If the MP decides to prescribe treatment, the results of that treatment will be noted in the system. Based on the outcome, the MP can proceed along the clinical pathway, or backtrack and try a different path. All choices of the MP are recorded by the system. Once a successful result is obtained, the system will increase the weightings of all business rules that were true along the successful pathway, and weaken the weightings of all true business rules along the unsuccessful pathways. Thus the system self-modifies based on experience. The next time through given the same circumstances, the system might display information in a different order based on the new weightings.

How does DCP Automate the Process:

As specified in U.S. patent application Ser. No. 12/814,058 for People Relationship Management, there are several components that make up a relationship.

Spheres—a sphere is a group of entities. The entity can be anything. An elemental sphere is a sphere that cannot be subdivided any further. There are three types of spheres:

Super-spheres: a sphere consisting of a group of other spheres. Spheres can be nested any number of levels.

Business-rule spheres: inclusion in this sphere is based on a business rule that tests the meta-data of other spheres for certain values. Inclusion within the sphere is based on the rule being true. For instance: the sphere of “People with Cough” includes people (spheres) where having cough=true.

Context spheres: this is an innovation of this patent application. A context sphere is the “universe” within which certain relationships exist. An example would be “Chronic cough pathway.”

Sphere data—is the information about a sphere. There can be sphere data pertaining to any sphere. For instance, for an elemental sphere such as a patient, his/her sphere data would be his/her demographic information, symptom and treatment history. For a larger sphere such as the patient care unit, sphere data can relate to their qualifications and experience. Any sphere data can be used in business rules to determine inclusion in another sphere. For instance, a sphere of cough sufferers would include elemental spheres representing patients who have cough as one of their symptoms.

Business rules—leverage meta-data about a sphere to determine inclusion in other spheres. Meta-data is “data about data.” The system of the present invention not only stores information pertaining to spheres, but information pertaining to the information. An example is a thing called: neck X-ray. One can test whether neck X-ray is positive or negative in determining which sphere the patient should be included in. The fact that neck X-ray is meta-data means that one can test for it without having to hard-code that anywhere in the system, so one can apply any criteria for inclusion to any sphere.

Business rules can be joined by logical operators to create complex rules. The types of operators are as follows:

AND condition—all conditions joined by the and must be true for inclusion in the sphere.

OR condition—any of the conditions being true would determine inclusion in the sphere.

Weightings—this is an enhancement over U.S. patent application Ser. No. 12/814,058. Each condition here will have a weighting factor. Some will be true and some not. The outcome is not inclusion or non-inclusion in the sphere, but probabilities of inclusion. It is up to the user to decide whether the sphere should be included in the super-sphere based on the probabilities provided by the system.

Relationship—a relationship is an interconnection between spheres. There can be a directional interrelationship (parent-child) or peer-to-peer. The relationship will inherit properties (business rules) from the context sphere that it is in. For example, a context sphere may have a rule that relationships within it should be owner-member. This would describe a hierarchical relationship. However, there may be two spheres within the structure that have a peer-to-peer relationship, such as co-heads of a department. The relationship type can be overridden at the relationship level just for those relationships for which that applies.

Security—DCP implements sphere-based security, which means that a sphere can be assigned the same privileges. Those that have different privileges are is a different sphere. Users of a pathway can collaborate on patient care. There are many collaboration tools on the market. However none of them have the flexibility of sphere-based security. Unlike social networking, DCP will need to keep patient confidentiality, while leveraging all relevant experts to collaborate in care. This requires dynamic rule-based security which only spheres can offer.

Integrating pathway hubs—the modification of the design presented in this application redefines a context as a type of sphere. This is significant in that it natively enables integrating pathway hubs. Integrating pathways is necessary when information about the condition leads the MP toward a different direction. DCP integrates them by allowing a sphere to spawn a whole new pathway. One can think of a context sphere as the universe the pathway is occurring in, however any node can transform you into a different “universe” (Context Sphere—see FIGS. 5 and 6).

Processing Example:

Jim makes an appointment with Dr. Sarah, a primary care physician, complaining of heartburn and a sense of a lump in the throat. Sarah brings her tablet computer with her to the initial consultation. After taking a proper clinical history and examining the patient, Dr. Sarah indicates on the tablet that Jim is at moderate risk for having medical complications from his disease and initiates the Gastroesophageal Reflux (GERD) pathway. The system suggests that Dr. Sarah instructs the patient on diet and lifestyle changes, starts the patient on medication to treat GERD, and sends the patient for esophageal screening to be sure that there are no obvious tumors or pre-cancerous changes to the esophagus (middle pathway in FIG. 2). The system orders the medication and the test through the Order Entry system on the back-end via web-services, transparent to the users. The tablet computer is a part of the computer arrangement of the invention that includes the interface for the medical professional to access the dynamic clinical pathway program in the server at an entry sphere and to receive suggestions for a clinical pathway based on a symptom of the patient or subject observed by the medical professional.

One month later the patient returns to see Dr. Sarah. The results of the test indicate a relatively normal esophagus, although the severity of the patient's initial symptoms and poor response to medication suggests the need for further testing. The pathway recommends that the patient undergo manometry (testing the pressure of the upper esophagus sphincter muscle), which reveals the pressure is unusually high in Jim's case (and noted in the system). As a result, the pathway suggests that Dr. Sarah treat Jim with muscle relaxants, and consider sending him to a specialist to inject botulinum toxin to his cricopharyngeus muscle. Had this test been uninformative, Dr. Sarah would have been instructed to backtrack to further tests, such as a CT-scan of the neck. If the botulinum toxin injection is successful, the pathway leading to that treatment would be strengthened.

### Advantages of the Invention

There can be process efficiencies gleaned from the medical profession. To use a well-worn metaphor, automating the administrative tasks is like picking the low hanging fruit. Yet the low hanging fruit is ripe for the picking in the medical industry, as it is notoriously under automated. Providing automated support for the knowledge worker (ACM) is analogous to harvesting the middle of the tree, because it is addressing more complex problems using more sophisticated tools.

Once the administration is fully automated and DCP alleviates the need for memorizing large amounts of information, the nature of health care will inevitably change. Medical professionals will be able to focus on care of the patient rather than memorization. Training will be more specific because there will be instantaneous access to experts in nuanced areas of medicine. Students will spend more time working with patients and less time in the classroom or library. Costs associated with health care will decrease as care for standard ailments can be managed by less costly resources, unnecessary tests and treatments avoided, and audit trails lessen the risk of malpractice litigation.

The immediate consequences of this system will be more cost effective care for minor ailments. Nurse practitioners and physician assistants (PAs) can establish pathways along practice guidelines and prescribe treatments. A physician will be brought in only if the condition is serious. Practice guidelines and audit trail will allow medical professionals to make sound decisions rather than practice defensive medicine. Medical students will focus on complex diagnoses, rather than memorization of that which will be systematized. Therefore, each physician will have more depth and/or breadth of knowledge in their specialty. Ultimately, care of the patient will be paramount, enhanced because burdensome processes and information failures will be abated.

In addressing any problem, it is best to plan a long term strategy and determine shorter term tactics that achieve mileposts along the strategic plan. Dynamic Clinical Pathways is just that. The advent of Adaptive Case Management and Extended Relationship Management are well suited frameworks within which to solve this problem, and see us down the pathway toward healthy lives without compromising our financial future.

Accordingly the DCP of the present invention will result in:
Better patient care;
Save costs;
Oversight and accountability;
Avoidance of malpractice lawsuits;
Self learning;
Contributes to body of knowledge;
Allowing collaboration of care among providers in different locations enabled by sphere based security; and
Integrating pathway hubs.

The system of the present invention to manage clinical pathways using conventional technology is feasible. Through careful analysis of the process, and leveraging and extending existing technologies, a system can be devised that will assist medical professionals in diagnosing and treating conditions. This is an application of Adaptive Case Management, in that it will provide decision support for knowledge workers.

The inventive Dynamic Clinical Pathways (DCP) is a computer software system which guides and monitors a medical professional in the task of diagnosing illnesses and prescribing treatment.

Extended Relationship Management (XRM) is an extension on the People Relationship Management System (PRM). PRM is based on Spheres, Contexts, Relationships and Business Rules. XRM extends this concept by viewing a Context as a type of Sphere. Therefore, spheres can contain relationships as well as other spheres.

This distinction is important because it allows a sphere, which when within a relationship acts as a node in a network structure, can explode into a new context type sphere containing its own relationships. Thus one can represent a micro/macro view of relationships. The previous invention could only represent nested spheres. Within a sphere, the sub-spheres have associativity—all sub-spheres are equally related. In a network, there is no associativity. This enhancement allows more flexible representation of complex levels of relationships (FIG. 1).

Another enhancement of XRM over PRM is that it provides weightings for business rules. Thus business rule firings can be weighted by relative importance. This provides for the implementation of fuzzy logic, where conflicting business rules can be fired and the system has a way of prioritizing their significance. PRM was meant for use with traditional workflow or business process software, where the rules surrounding pathways or behaviors are well defined. XRM can be applied to applications where the pathways are not well defined. XRM-enabled applications provide decision support for the knowledge worker, who will use his expertise in conjunction with information provided by the system, to make critical decisions. Positive outcomes are indicated to the system, which will strengthen or weaken weightings in the business rules, so it can “learn” from experience.

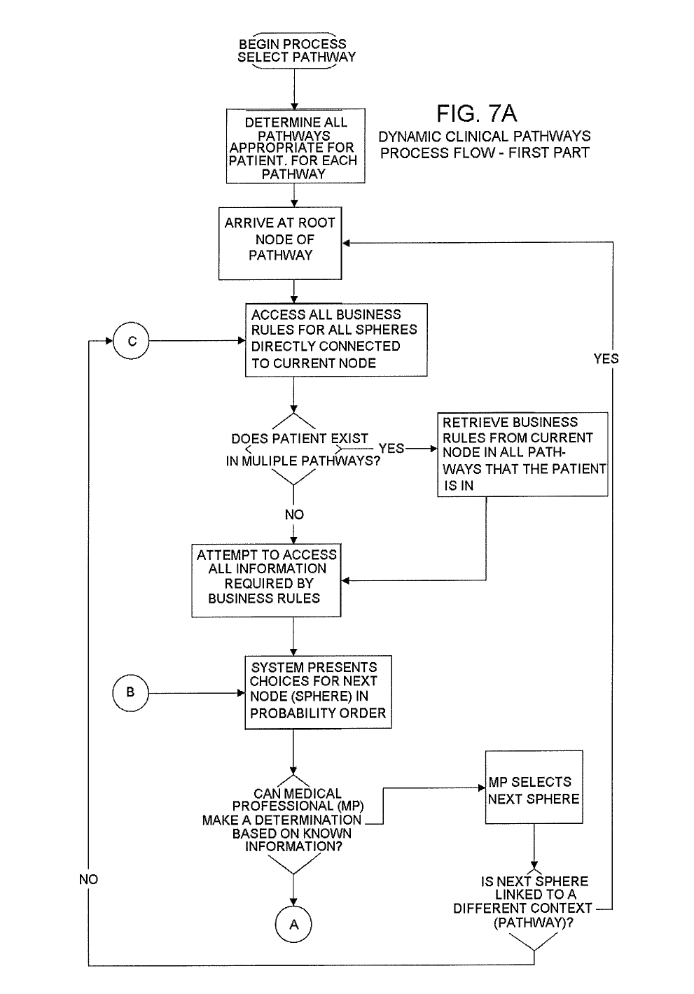

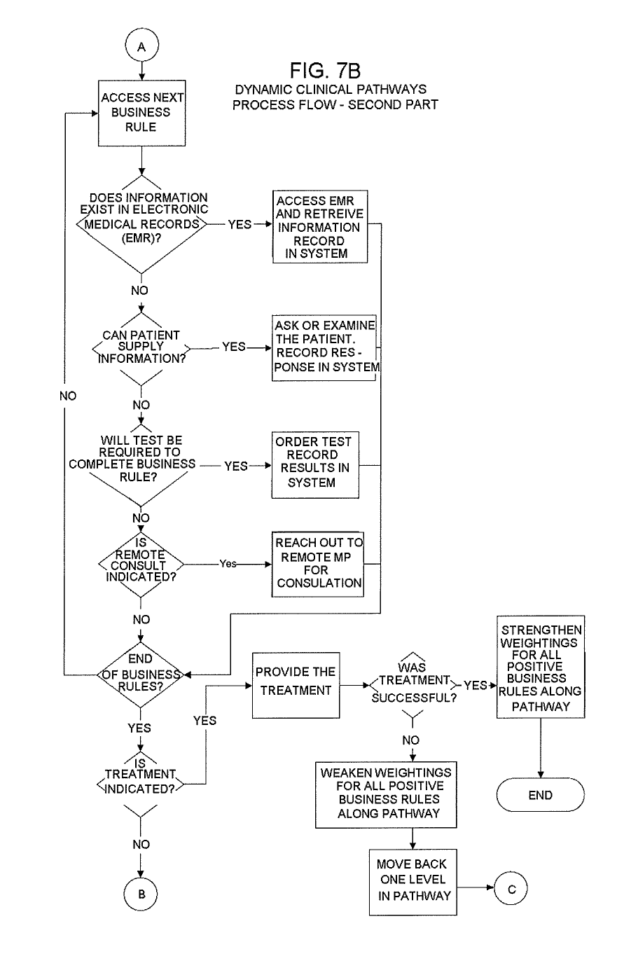

Referring now to FIGS. 7A and 7B, the system of the invention is embodied in the computer program illustrated as a flowchart in detail. Those skilled in the art of this invention and in the art of computer programming can create a computer program in any one of multiple computer languages, flowing the teaching of this flowchart, to create the system of, and to practice the present invention.

While a specific embodiment of the invention has been shown and described in detail to illustrate the application of the principles of the invention, it will be understood that the invention may be embodied otherwise without departing from such principles.

### LIST OF REFERENCES

[1] Bohmer R M, Lee T H, “The shifting mission of healthcare delivery organization,” N Engl J Med, 361: 551-3, 2009.
[2] Porter M E, “A strategy for health care reform—toward a value-based system,” N Engl J Med, 361: 109-112, 2009.
[3] Every N R, Hochman J, Becker R, Kopecky S, Cannon C P, “Critical Pathways. A review,” Circulation, 101:461-465, 2000.
[4] Altman K W, Prufer N, Vaezi M F, “A review of Clinical Practice Guidelines for reflux disease: toward creating a clinical protocol for the otolaryngologist,” Laryngoscope, in press.
[5] Altman K W, Prufer N, Vaezi M F, “The challenge of protocols for reflux disease—A review and development of a critical pathway,” Otolaryngology Head Neck Surgery, 2011 April; 121(4):717-23.
[6] Altman K W, Irwin R S, “Cough: A new frontier in otolaryngology,” Otolaryngology Head Neck Surgery, 2011 March; 144(3):348-52.
[7] Altman R, “People Relationship Management—Completing the BPM Value Proposition,” 2009 BPM Workflow Handbook.

What is claimed is:

1. A dynamic clinical pathway system for helping medical professionals make informed decisions on courses of treatment for a subject after observing one or more symptom exhibited by the subject, comprising:
a computer arrangement containing at least one computer connected to an Electronic Medical Records system and an Order Entry system for allowing real time access and updates;
a dynamic clinical pathway program programmed into the computer arrangement for storing a plurality of connected spheres in a multi dimensional model, at least some of the spheres being seeded with clinical practice guidelines provided by medical experts and containing documented evidence for clinical pathways based on or extrapolated from symptoms, the seeded spheres being configured with business rules for inclusion according to clinical protocols, and being linked in relationships that comprise context spheres of clinical pathways based on the documented evidence, the business rules being based on indicative information about at least one of: the clinical practice guidelines; the symptoms; and test results that indicate compliance with a business rule and therefore inclusion in the sphere;
the computer arrangement including an interface for a medical professional to access the dynamic clinical pathway program at an entry sphere and to receive suggestions for clinical pathways to take based on at least one business rule of the subject, the interface providing the medical professional with an Electronic Medical Record of the subject and the allowing access for the medical professional to made decisions to order treatments or tests via the Order Entry system;
the dynamic clinical pathway program recording an audit trail of all decisions made by the medical professional in the clinical pathway and for using that audit trail to set a pathway as being a strong pathway or a weak pathway based on the effectiveness of the decisions to treat the subject; and
the dynamic clinical pathway program adjusting weightings on the business rules for preferentially suggesting the strong pathways over the weak pathways in subsequent uses of the dynamic clinical pathway system.

2. The system of claim 1, wherein the computer arrangement comprises a hand held computing device for providing the interface for the medical professional, and an application server computer connected to the hand held computing device, the application server computer being connected to the Electronic Medical Records system and to the Order Entry system through a web service.

3. The system of claim 1, wherein the a computer arrangement comprises a hand held computing device for providing the interface for the medical professional, and an application server computer connected by a wireless connection to the hand held computing device, the application server computer being connected to the Electronic Medical Records system and to the Order Entry system through a web service.

4. The system of claim 1, wherein the computer arrangement comprises a hand held computing device for providing the interface for the medical professional, and an application server computer connected to the hand held computing device, the application server computer being connected to the Electronic Medical Records system and to the Order Entry system.

5. The system of claim 1, wherein the a computer arrangement comprises a hand held computing device for providing the interface for the medical professional, and an application server computer connected by a wireless connection to the hand held computing device, the application server computer being connected to the Electronic Medical Records system and to the Order Entry system.

6. The system of claim 1, wherein the system has the ability to represent and process linked pathways comprising pathways that can spawn other pathways based on observed conditions and the medical professional's determination, and to manage complexity and interaction of multiple pathways occurring simultaneously and in parallel, and switch from one pathway to another as deemed appropriate by the medical professional.

7. The system of claim 1, wherein the system has the ability to represent the patient experience with multiple health care providers so that the system can represent the patient or provider view of the process as well as the overall workflow in determining diagnosis and treatment.

8. The system of claim 1, wherein the system can manage complex interconnection of spheres determined by business rules for any practical application.
